(19) United States
(12) Patent Application Publication
(10) Pub. No.: US 2007/0271887 A1
(43) Pub. Date: Nov. 29, 2007

(54) Nestable Filter and Frame

(76) Inventors: Mike Osborne, Louisville, KY (US); Steve Kapsalis, Prospect, KY (US); Dennis Porter, Columbia, MO (US); Mike Montague, Louisville, KY (US)

Correspondence Address: MIDDLETON & REUTLINGER, 2500 BROWN & WILLIAMSON TOWER, LOUISVILLE, KY, 40202, US

(21) Appl. No.: 11/420,141

(22) Filed: May 24, 2006

(51) Int. Cl. B01D 46/00

(52) U.S. Cl. 55/495

(57) ABSTRACT

A nestable fluid filter comprises a frame surrounding a filter media, the frame has a unitary portion unitary with an outer portion of the filter media, depending from the unitary portion is a portion flaring outwardly at an obtuse angle from the unitary portion, the flared portion is unitary about the filter media, a mounting surface depends from the flared portion and is in a substantially parallel plane with the filter media.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF INVENTION

The present invention relates to filter and frame combinations having a nestable configuration.

### BACKGROUND OF THE INVENTION

Air filter units for use in forced air heating and air conditioning systems have long been recognized. Traditionally, these filter units comprise a fibrous glass air filter having an inwardly facing U-channel fiberboard as a frame. It later became apparent that this configuration lacked a structure that enabled the filter units to be stored, shipped, or displayed in a desired space. The need for a compact nestable filter and frame combination was then recognized, see for example Best, U.S. Pat. No. 3,023,839, Copenhefer, U.S. Pat. No. 3,830,045, Champlin, U.S. Pat. No. 4,086,071, Latakas, et al. U.S. Pat. No. 4,105,423, Miller, U.S. Pat. No. 5,800,588, and Hoeffken, U.S. Pat. No. 6,033,454. In Best, V openings between ends of straight fiberboard side sections are blocked by paper tape. In Copenhefer, the frame has a top and bottom half comprised of fiberboard and folded over and flared outwardly from the filter. In Champlin, frame members are fold inwardly to conserve space. In Latakas, et al., a paperboard frame has edge panels between two flared flanges. In Miller, a frame member forms a channel having a “V” configuration. In Hoeffken, side rails have tabs that when joined forms a frame having an obtuse angle with the filter media. These filters may require assembly by one other that the manufacturer, have a fiber board frame subject to degradation from moisture, or lack the structural strength and/or economic benefit sought with the use of nestable filters.

### SUMMARY OF THE INVENTION

In accordance with this invention, generally stated, a compact, nestable air filter is provided as well as processes for economically producing the same which has a frame unitary with a filter media. When the filter is confined within an air conditioner, heating duct housing, or other receiver, it is generally slipped between facing channels, in which condition, an external force is applied to the frame portion. For shipping or storing, a portion of the frame flaring outwardly at an obtuse angle from the filter media permits the nesting of the filters, thus conserving space.

The nestable fluid filter comprises a frame surrounding a filter media, the frame has an unitary portion unitary with an outer edge of the filter media, depending from the unitary portion is a portion flaring outwardly at an obtuse angle from the unitary portion. Such configuration enables filters to nest with each other making a substantial portion of nested filter and frame combinations adjacent a proximate filter and frame combination minimizing void space when stored, shipped, boxed, or stacked in anyway. Preferably, the nestable fluid filter comprises a polymeric material such as polyurethane, thermoplastic olefins, polycarbonates, polyesters, polypropylene, polyamides, polyethylene, polystyrene, or any combinations thereof. Optionally, the filter media and frame portions of the fluid filter are comprised of the same material wherein the frame portion is hardened, preferably by the application of heat making the frame portion in a rigid state. Strengthening and/or filler materials may be incorporated into the frame component of the nestable filter. The nestable filter may be rectangular, oval, or have any outer configuration for fitting into a housing or duct. The frame portion of the nestable fluid filter may have a colorant and/or an embossing in a graphical display surface. The filter media may be pleated or in a pad configuration. Optionally, a faceguard may be incorporated into the fluid filter.

The process for making the nestable fluid filter media and frame comprises placing at least an outer edge portion of filter media onto a stationary mold and applying an insertion mold to the opposite side of the filter media. An outer portion of the filter media is then placed into a hardened state with the application of a solidifying material, preferably the same or other polymeric material, or heat, making the frame rigid.

### BRIEF DESCRIPTION OF THE FIGURES

Reference to the figures discloses several embodiments of the nestable fluid filter and frame as well as methods of making and are not to be interpreted as limiting the scope of the instant invention.

FIG. 1 is a cross-sectional view of an embodiment of the nestable fluid filter having a pad filter media;

FIG. 2 is a cross-sectional view of an embodiment of the nestable fluid filter having a pleated filter media;

FIG. 3 is a cross-sectional view of an embodiment of the nestable fluid filter having a pad filter media and a strengthened frame configuration;

FIG. 4 is a cross-sectional view of an embodiment of the nestable fluid filter having a pleated filter media and a strengthened frame configuration;

FIG. 5 is a perspective view of a nestable fluid filter showing a unitary pleated filter media and frame.

FIGS. 6A and 6B is a cut-away cross-sectional view of an embodiment of open cavity molds used to produce the nestable fluid filter and a method of use.

FIGS. 7A and 7B is a cut-away cross-sectional view of an embodiment of open molds used to produce the nestable fluid filter and an interior spray method of making.

FIG. 8 is a cut-away cross-sectional view of an embodiment of open molds used to produce the nestable fluid filter and an exterior spray method of making.

FIG. 9 is a cut-away cross-sectional view of an embodiment of closed molds used to produce the nestable fluid filter and a method of making using a heating process.

FIG. 10 is a perspective view of a nestable fluid filter having unitary pleated filter media with a graphical display area and a face guard.

FIG. 11 is a top view of a nestable fluid filter showing a unitary pleated filter media and frame having an alternative embodiment of a face guard incorporated within the filter media.

### DETAILED DESCRIPTION OF THE PREFERRED EMBODIMENTS

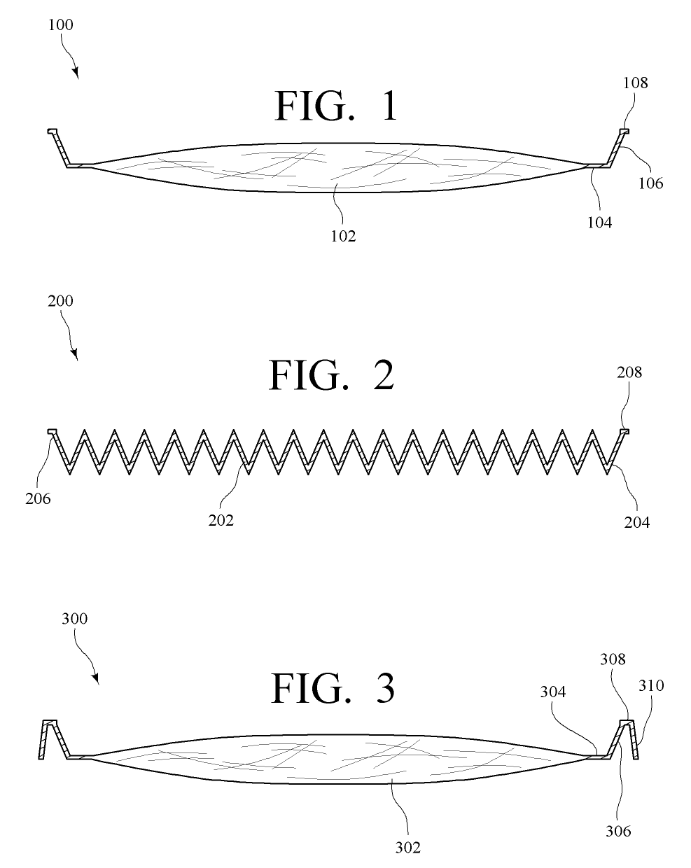

FIGS. 1-11 illustrate several embodiments of the nestable fluid filter and methods of making. Other embodiments and methods will become apparent to persons having ordinary skill in the art upon a reading of the instant disclosure, as such, the instant disclosure shall not be construed as limiting this invention.

FIG. 1 shows nestable fluid filter 100 having filter media 102. Nestable fluid filter 100 comprises a frame portion surrounding filter media 102. The frame portion has unitary portion 104 unitary with an outer peripheral portion of filter media 102. Depending from unitary portion 104 is support portion 106 flaring outwardly at an obtuse angle greater than 90° from a plane central with filter media 102 and unitary portion 104. Filter media 102 optionally depends into support portion 106 extending the unitary portion into the frame. Flared portion 106 is unitary about filter media 102. Mounting surface 108 depends from flared portion 106 and is a substantially flat uniform surface substantially parallel with filter media 102. Mounting surface 108 has a terminating edge of flared portion 106 depending from unitary portion 104 wherein filter media 102 may be incorporated through out. Such a nestable configuration permits the stacking and matingly engagement of unitary nestable filters 100 conserving space and providing a relatively strong and resilient filter and frame combination.

In this embodiment, filter media 102 is in the form of a pad filter preferably with a substantially uniform thickness. Preferably, filter media 102 has a polymeric material such as polyurethane, thermoplastic olefins, polycarbonates, polyesters, polypropylene, polyamides, polyethylene, polystyrene, or any combination thereof and more preferably this polymeric material is in a fibrous form. Preferably, filter frame portions 104, 106, and 108 also have a polymeric material such as polyurethane, thermoplastic olefins, polycarbonates, polyesters, polypropylene, polyamides, polyethylene, polystyrene, or any combination thereof. Advantageously, filter media 102 and filter frame portions 104, 106, and 108 are all comprised of the same material wherein frame portions 104, 106, and 108 are in a hardened or rigid state. Preferably, the common material forming filter media 102 and frame portions 104, 106, and 108 is polyurethane. Any or all of frame portions 104, 106, and 108 may have a strengthening material such as paper, metal, plastic, glass fibers, and combinations thereof selectively positioned within or evenly distributed through out. The strengthening material may be rigid corner or side pieces unitarily formed with any or all of frame portions 104, 106, and 108. Additionally or alternatively, the strengthening material(s) can be fine pieces dispersed throughout a polymeric material. Optionally, a polymeric material forming any or all of frame portions 104, 106, and 108 may have a filler material such as calcium carbonate and optionally a colorant. Nestable fluid filter 100 may have a rectangular, oval, or other configuration for mounting into a variety of ducts or housings. Optionally, filter media 102 extends throughout the frame and is hardened making unitary portion 104, support portion 106, and mounting surface 108 in a rigid state.

FIG. 2 shows nestable fluid filter 200 having pleated filter media 202. Nestable fluid filter 200 comprises a frame portion surrounding filter media 202. The frame portion has unitary portion 204 unitary with an outer peripheral portion of filter media 202. Depending from unitary portion 204 is support portion 206 flaring outwardly at an obtuse angle greater than 90° from a plane central with filter media 202. Filter media 202 optionally depends into support portion 206 extending the unitary portion into the frame. Flared portion 206 is unitary about filter media 202. Mounting surface 208 depends outwardly from flared portion 206 and is a substantially flat uniform surface substantially parallel with a central plane within filter media 202. Mounting surface 208 has a terminating edge of flared portion 206 depending from unitary portion 204 wherein filter media 202 may be incorporated through out increasing the strength of the frame portion. Such a nestable configuration permits the stacking and matingly engagement of pleated nestable filters 200. Optionally, filter media 202 extends throughout the frame and is hardened in an outer portion making unitary portion 204, support portion 206, and mounting surface 208 a unitary rigid material.

FIG. 3 shows nestable fluid filter 300 having a strengthened frame configuration. Nestable fluid filter 300 comprises a frame portion surrounding filter media 302. The frame portion has unitary portion 304 unitary with an outer peripheral portion of filter media 302. Depending from unitary portion 304 is support portion 306 flaring outwardly at an obtuse angle greater than 90° from a plane central with filter media 302 and unitary portion 304. Filter media 302 optionally depends into support portion 306 extending the unitary portion into the frame. Flared portion 306 is unitary about filter media 302. Mounting surface 308 depends from flared portion 306 and is a substantially flat uniform surface substantially parallel with filter media 302. Depending at an obtuse angle from mounting surface 308 is flange 310 providing structural support to the frame. Filter media 302 may be incorporated through out unitary portion 304, support portion 306, mounting surface 308, and flange 310. Optionally, filter media 302 extends throughout the frame and is hardened making unitary portion 304, support portion 306, mounting surface 308, and flange 310.

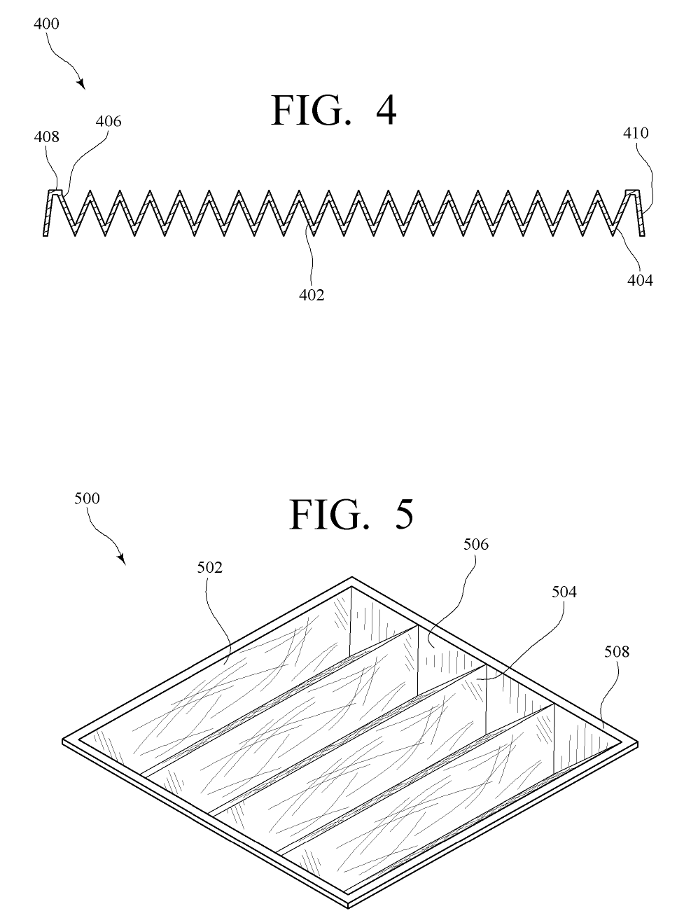

FIG. 4 shows nestable fluid filter 400 having pleated filter media 402. Nestable fluid filter 400 comprises a frame portion surrounding filter media 402. The frame portion has unitary portion 404 unitary with an outer peripheral portion of filter media 402. Depending from unitary portion 404 is support portion 406 flaring outwardly at an obtuse angle greater than 90° from a plane central with filter media 402. Filter media 402 optionally depends into support portion 406 extending the unitary portion into the frame. Flared portion 406 is unitary about filter media 402. Mounting surface 408 depends outwardly from flared portion 406 and is a substantially flat uniform surface substantially parallel with a central plane within filter media 402. Depending at an obtuse angle from mounting surface 408 is flange 410 providing structural support to the filter frame. Filter media 402 may be incorporated through out unitary portion 404, support portion 406, mounting surface 408, and flange 410. Optionally, filter media 402 is extends throughout the frame and is hardened making unitary portion 404, support portion 406, mounting surface 408, and flange 410.

FIG. 5 shows nestable fluid filter 500 having unitary pleated filter media 502 and frame. Nestable fluid filter 500 comprises a frame portion surrounding and unitary with pleated filter media 502. The frame portion has unitary portion 504 unitary with an outer peripheral portion of filter media 502. Depending from unitary portion 504 is support portion 506 flaring outwardly at an obtuse angle greater than 90° from a plane central with filter media 502. Filter media 502 optionally depends into support portion 506 extending the unitary portion into the frame. Flared portion 506 is unitary about filter media 502. Mounting surface 508 depends outwardly from flared portion 506 and is a substantially flat uniform surface substantially parallel with a central plane within pleated filter media 502. Mounting surface 508 has a terminating edge of flared portion 506 depending from unitary portion 504 wherein filter media 502 may be incorporated through out. Optionally, filter media 502 extends throughout the frame and is in a hardened state making unitary portion 504, support portion 506, and mounting surface 508.

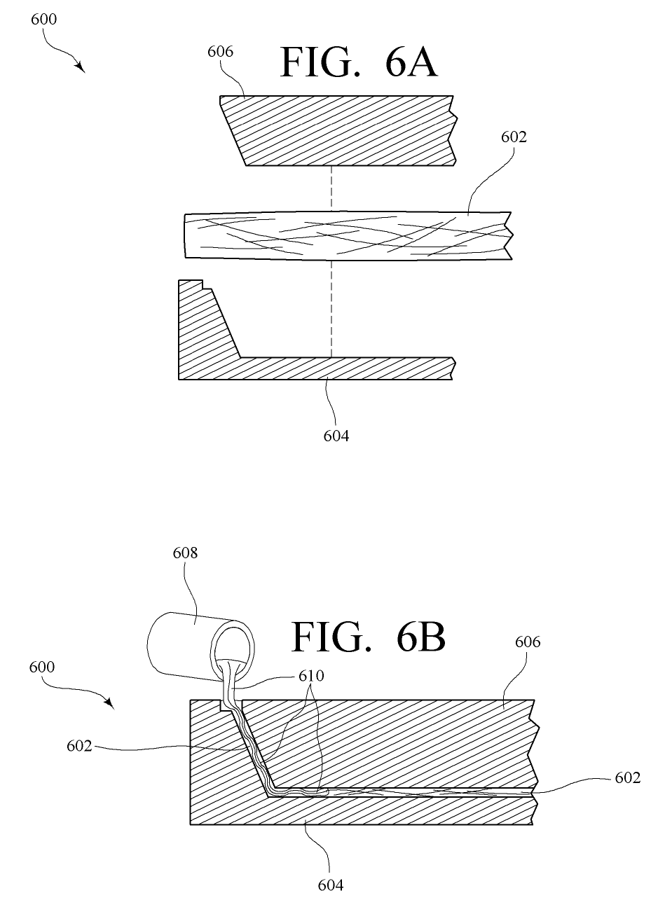

FIGS. 6A and 6B show open cavity molds and a method of use. The mold components may be comprised of plastic or metal. Stationary mold 604 has a cavity, either rectilinear or circular in configuration, with an exposed horizontal surface and outwardly slanted, at an obtuse angle and bevel from the top of the upper edge. A section of filter media 602, pleated or pad, is inserted by hand or machine into stationary mold 604. Insertion mold 606 is then inserted onto filter media 602 compressing filter media 602 onto the horizontal and outwardly slanted surfaces of stationary mold 604, as shown in FIG. 6B. A polymeric material 610, preferably polyurethane, with the appropriate properties is introduced or poured from container, tube, or other polymeric delivery mechanism 608 into the open gap between stationary mold 604 and insertion mold 606 encapsulating an outer peripheral portion of filter media 602 and forming a film of polymer that extends between the compression edges of insertion 606 and stationary 604. Pressure applied in introducing polymer 610 to filter media 602 and/or capillary action within filter media 602 drawing polymer 610 in between insertion mold 606 and stationary mold 604 an appropriate distance, as shown in FIG. 6B, are examples of controllable factors in controlling the distance polymer 610 penetrates filter media 602. The distance polymer 610 travels between insertion mold 606 and 604 may be controlled by adjusting other factors such as the amount of polymer 610 applied, viscosity of polymer 610, cure time of polymer 610, pressure applied forcing polymer 610 between molds 604 and 606, as well as the pressure applied on filter media 602 with insertion mold 606 and stationary mold 604. The extent to which filter media 602 is exposed to polymer 610 after insertion mold 606 is placed into stationary mold 604 can be adjusted by cutting filter media 602 to the appropriate dimensions allowing for minimal to fully unitary reinforcement of the filter frame with filter media 602.

Filter media 602 may be a pad (simple fiberglass, low efficiency filters), a modified pad (small pleat height/closed pleats) or even a pleated filter pack (MERV, ASHREA, HEPA and ULPA). Filter media 602 may have a polymeric material such as polyurethane, thermoplastic olefins, polycarbonates, polyesters, polypropylene, polyamides, polyethylene, polystyrene, or any combination thereof and preferably has polyurethane. The use of filter media 602 in the configuration of a flat pad provides a mating surface between stationary mold 604 and insertion mold 606 that is flat and provides continuous compression points to prevent the polymer from wicking via capillary action into filter media 602 an undesirable distance. The use of filter media 602 in the configuration of a modified pad, having small pleats, the a mating surface between stationary mold 604 and insertion mold 606 may have some contours to match with the pleats in filter media pack 602 and there will be some compression between stationary mold 604 and insertion mold 606 to prevent over-wicking. The use of filter media 602 in the configuration of a fully pleated media pack the mating surface between stationary mold 604 and insertion mold 606 are contoured, like “clam shells”, with matching “V-shaped”, “U-shaped”, or essentially parallel-spaced pleats providing compression points along the entire mating surface between stationary mold 604 and insertion mold 606.

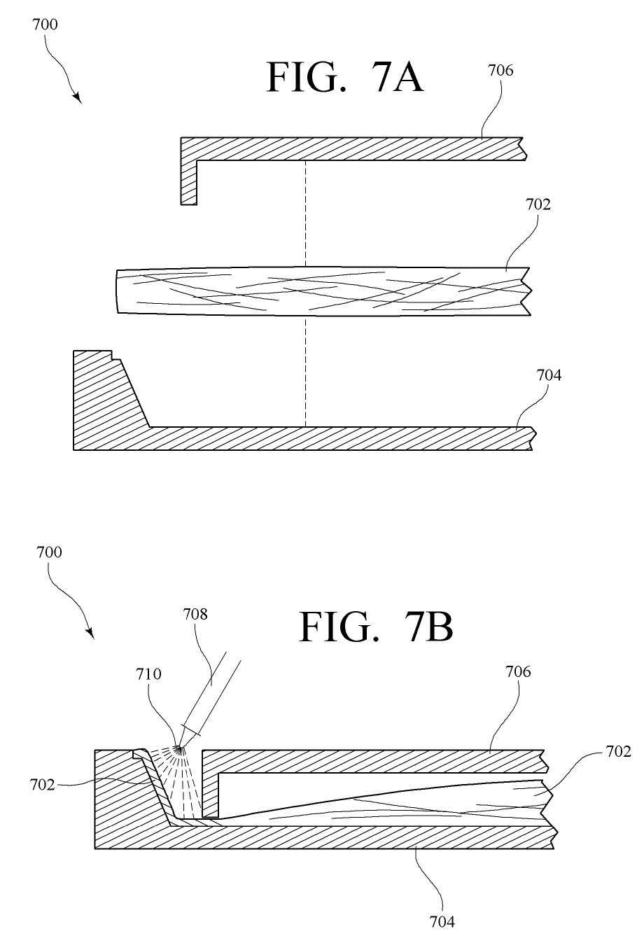

FIGS. 7A and 7B show on open mold design and a method of use. Molds 706 and 704 are open molds which are not injected into the mold under pressure as is often done with closed molds such as the molds shown in FIGS. 6A and 6B. Specifically, molds 706 and 704 are used in an interior spray molding process. These molds are preferred to comprise plastic or metal. Stationary mold 704 has a portion which comprises a cavity, either rectilinear or circular in nature, with an exposed horizontal surface and outwardly slanted, angled greater than 90°, bevel from the bottom to the upper edge. Filter media 702 is inserted, either by hand or machine, wherein insertion mold 706 is inserted onto filter media 702, compressing a portion of filter media 702 onto the horizontal surface. Optionally, a strengthening material such as paper, metal, plastic, glass fibers, and combinations thereof are positioned within or evenly distributed through out filter media 702 between stationary mold 704 and insertion mold 706. The strengthening material may be rigid corner or side pieces unitarily formed with any or all of frame portions. A polymer 710, preferably polyurethane, with the appropriate properties is sprayed with applicator 708 along the exposed inner edges of the open cavity of stationary mold 704 encapsulating filter media 702 and forming a film of polymer that extends from the edge of insertion mold 706 to the upper edge of stationary mold 704. The extent to which the filter media 702 is exposed after insertion mold 706 is placed adjacent filter media 702 can be adjusted to allow for filter media 702 to be only slightly encapsulated into applied polymer 710 or to allow for filter media 702 to be fully encapsulated to allow for reinforcement or further extension of filter media 702 unitary with a filter frame. Such method can provide a filter fiberglass reinforced polyurethane thermoplastic frame, a synthetic fiber reinforced thermoplastic frame, or other unitary reinforced frame around filter media 702. The extension of filter media 702 into a frame may be a partial extension for partial reinforcement. The spray of polymer 710 against the internal outer wall of stationary mold 704 allows for the introduction of trademarks, product identification name/bar codes, or other information and/or graphics to be embossed into the finished outer surface of the filter frame by having said embossings in the outwardly slanted surface of stationary mold 704. Additionally or alternatively, skins of decorative materials having trademarks, product identification names/bar codes, and/or other information or graphics can be inserted into stationary mold 704 prior to the introduction of filter media and polymer 710 and held in place by vacuum or some other method to allow for incorporation of high quality images directly into the outer surface of a filter frame. Also, special paintable mold release agents may be used in the production of filters to allow the use of standard or special printing inks and pigments for applying trademarks, product identification names/bar codes and other information.

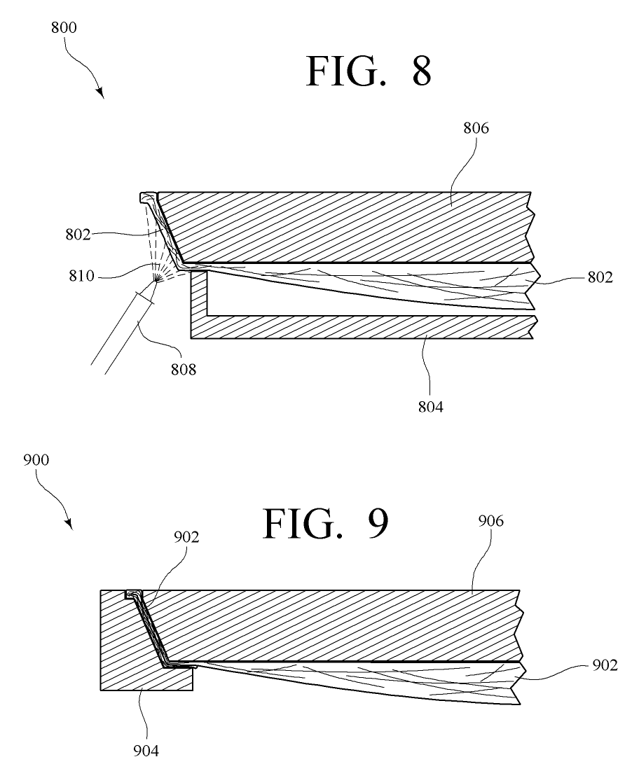

FIG. 8 shows an exterior spray open mold design and a method of use. Advantageously, stationary mold 806 and insertion mold 804 are comprised of plastic or metal. Stationary mold 806 has an external surface, preferably either rectilinear or circular in nature, with an exposed horizontal surface and out outwardly slanted, angled at more than 90°, bevel from the bottom to the upper edge in which a section of filter media 802 is applied, either by hand or machine. Insertion mold 804 is then inserted onto filter media 802 compressing a portion of filter media 802 onto the horizontal surface of stationary mold 806. A polymeric solution 810, preferably polyurethane, with the appropriate properties is sprayed with applicator 808 along the exposed outer edges of filter media 802 beyond insertion mold 804 both encapsulating filter media 802 and forming a film of polymer 810 that extends from the edge of the insertion mold 804 to the outer edge of stationary mold 806. The extent to which the filter media 802 is exposed after insertion mold 804 is placed is adjustable with varying the size of insertion mold 804 and/or stationary mold 806. Filter media 802 may be only slightly encapsulated with polymer 810 or may be fully encapsulated to allow for structural reinforcement of the outer edges of filter media 802 forming a frame there around. The frame formed about filter media 802 is preferably structurally sound such as produced with a fiberglass reinforced polyurethane thermoplastic or a synthetic fiber reinforced thermoplastic. Filter media 802 may extend only slightly beyond insertion mold 804 or optionally may extend to the outer edge of insertion mold 806, thus filter media 802 may provide a partial reinforcement or full reinforcement of a frame about filter media 802. Typically, spray molding does not require the exposed surface of stationary mold 806 to have a mold release agent placed thereon, therefore, trademarks, product identification name/bar codes, other information and/or graphics can be applied to the outer surface of insertion mold 806 transferring same to the filter frame.

A typical spray mold process includes the steps placing a filter media into a stationary mold and centrally inserting the insertion mold onto the filter media. A desired pressure is applied to an outer portion of the filter media between the insertion mold and the stationary mold. Optionally, strengthening materials are placed about the portion of the stationary mold that extends beyond the insertion mold. Strengthening materials may be placed onto the insertion mold prior to the placement of the filter media as well. The timing of the placement of the strengthening materials allows a specific side or both sides of the portion of filter media uniform with the frame to have strengthening materials adjacent thereto. A polymeric containing material is then sprayed about the portion of the stationary mold that extends beyond the insertion mold having at least an outer portion of the filter media exposed. The polymeric containing material is then allowed to cure. The insertion mold is lifted from the stationary mold and the unitary frame and filter media are demolded. Preferably the process is an automated process wherein the molds having the filter media and optional strengthening material are either rotated about a stationary spray applicator or remain stationary while the spray applicator moves about the outer portion of the insertion mold.

FIG. 9 shows a closed mold design and a method of use. Advantageously, stationary mold 906 and insertion mold 904 are comprised of a heat resilient plastic or metal. Stationary mold 906 is preferably either rectilinear or circular in configuration with a horizontal surface and outwardly slanted, at an obtuse angle and bevel, greater than 90° from the horizontal surface. A section of filter media 902, pleated or pad, is inserted by hand or machine onto stationary mold 906. Insertion mold 904 is then inserted onto filter media 902 compressing filter media 902 onto the horizontal and outwardly slanted surfaces of stationary mold 906, as shown in FIG. 9. The portions of filter media 902 between insertion mold 906 and insertion mold 904 is then made rigid by activating the thermosetting properties of bicomponent fibers in filter media 902 to bond the fibers in filter media 902 which is preferably in the form of a fibrous nonwoven mat. A process such as sonic welding or a heated plenum can be used to create the bond of the fibers in an outer portion of filter media 902 forming a unitary frame about filter media 902. Preferably, filter media 902 is fiberglass or other synthetic media subject to bonding with the application of heat. Filter media 902 can optionally be reinforced between stationary mold 906 and insertion mold 904 to additional rigidity, if needed, by the application of polymeric materials such as polyurethane or polyamide (i.e. hot melt), either trough out the area between molds 906 and 902 or at specific weak points, corners, or edges. Reinforcing materials may be fashioned from strips of the bondable nonwoven matting making up filter media 902 and heat activating filter media 902 and any added support materials to induce rigidity to the frame portion of the filter and essentially flatten the mat making it a rigid and non-permeable frame. Preferably, in this embodiment the frame portion and the filter media of the nestable filter and frame are comprised of the same materials economically making a nestable filter and frame combination.

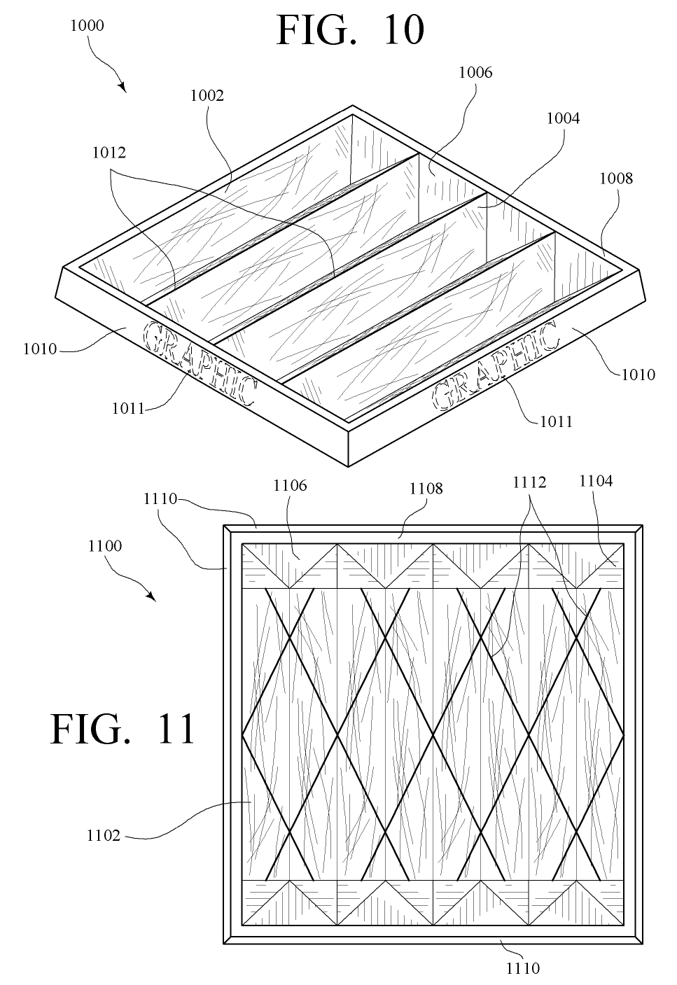

FIG. 10 shows nestable fluid filter 1000 having unitary pleated filter media 1102 and frame. Nestable fluid filter 1000 comprises a frame portion surrounding and unitary with pleated filter media 1002. The frame portion has unitary portion 1004 unitary with an outer peripheral edge of filter media 1002. Depending from unitary portion 1004 is support portion 1006 flaring outwardly at an obtuse angle greater than 90° from a plane central with filter media 1002. Filter media 1002 optionally depends into support portion 1006 extending the unitary portion into the frame. Flared portion 1006 is unitary about filter media 1002. Mounting surface 1008 depends outwardly from flared portion 1006 and is a substantially flat uniform surface substantially parallel with a central plane within pleated filter media 1002. Depending at an obtuse angle from mounting surface 1008 is flange 1010 providing structural support to the frame. Filter media 1002 may be incorporated through out unitary portion 1004, support portion 1006, mounting surface 1008, and flange 1010. Shown here is optional graphical display area 1011 displaying trademarks, product identification name/bar codes, or other information and/or graphics which may be embossed in the mold forming filter, or alternatively, skins of decorative materials having trademarks, product identification names/bar codes, and/or other information or graphics may be inserted into a mold prior to the hardening of the frame portion of filter 1000. Also shown here is optional faceguard 1012. Faceguard 1012 may be in the form of cable-stays reinforcing pleated or pad media. Shown here, faceguard 1012 is in the form of strips depending between opposing mounting surfaces 1008 unitary with the apex of the pleats within filter media 1002. Faceguard 1012 may be in the form of cable-stays or treated media. Cable-stays are typically tight strings that span filter media 1002 and made unitary there with while treated media 1002 may be in the form of hardened filter media (typically hardened by the application of heat), added polymeric material (i.e. hot melt), or other material added at the apex of the pleats of filter media 1002 strengthening the pleats increasing their resistance of collapsing while in use as the force that results from ventilation air passes there through.

FIG. 11 shows nestable fluid filter 100 having unitary pleated filter media 1102 and frame. Nestable fluid filter 100 comprises a frame portion surrounding and unitary with pleated filter media 1102. The frame portion has unitary portion 1104 unitary with at least an outer peripheral edge of filter media 1102. Depending from unitary portion 1104 is support portion 1106 flaring outwardly at an obtuse angle greater than 90° from a plane central with filter media 1102. Filter media 1102 optionally depends into support portion 1106 extending the unitary portion into the frame. Flared portion 1106 is unitary about filter media 1102. Mounting surface 1108 depends outwardly from flared portion 1106 and is a substantially flat uniform surface substantially parallel with a central plane within pleated filter media 1102. Depending at an obtuse angle from mounting surface 1108 is flange 1110 providing structural support to the frame. Filter media 1102 may be incorporated through out unitary portion 1104, support portion 1106, mounting surface 1108, and flange 1110. Also shown here is optional faceguard 1112. Faceguard 1112 may be in the form of strengthened filter media (i.e. hardened by the application of heat) or cable-stays reinforcing pleated media 1102. Shown here, faceguard 1112 is in the form of strips depending between mounting surfaces 1108 in a grid pattern about and unitary with filter media 1102. Faceguard 1112 is preferably treated media in the form of hardened filter media (typically hardened by the application of heat), added polymeric material (i.e. hot melt), or other material added to the pleats of filter media 1102 strengthening the pleats increasing their resistance of collapsing while in use as the force that results from ventilation air passes there through. It is to be understood that faceguards 1012 and 1112 may be applied to pad filter media as well as pleated filter media.

The unitary nestable filter and frame of the instant invention has a frame portion surrounding and unitary with a filter media portion. The filter media may be in the form of a pad or a pleated arrangement. Preferably, the nestable fluid filter and/or frame comprise a polymeric material such as polyurethane, thermoplastic olefins, polycarbonates, polyesters, polypropylene, polyamides, polyethylene, polystyrene, or any combinations thereof. Optionally, the filter media and frame portions of the fluid filter are comprised of the same material. In any embodiment, strengthening and/or filler materials may be incorporated into the frame component of the nestable filter. Any or all of frame portions in any embodiment may have a strengthening material such as paper, metal, plastic, glass fibers, and combinations thereof selectively positioned within or evenly distributed through out. The strengthening material may be rigid corner or side pieces unitarily formed with any or all of frame portions. Additionally or alternatively, the strengthening material(s) can be fine pieces dispersed throughout a polymeric material. Optionally, a polymeric material forming any or all of frame portions may have a filler material such as calcium carbonate and optionally a colorant. Optionally, a face guard may be incorporated in the filter media.

Polyurethane is a preferred material of construction in each embodiment shown because it allows the use of the open molds and the closed molds. Polyurethane can be applied as a spray onto an open surface mold or as a neat liquid into an open cavity. Polyurethane can be either non-foaming or foaming, extended with fillers (such as calcium carbonate) or diluents. The properties of the polyurethane can be adjusted for hardness, from flexible to rigid, as may be desired for a particular frame portion. The kinetics for cure times, gel times, pot life, and demold times can be varied. Polyurethane may be colored by the addition of additives such as iron oxides for red.

1. A nestable fluid filter comprising a frame surrounding a filter media, said frame having an unitary portion unitary with an outer portion of said filter media, depending from said unitary portion is a portion flaring outwardly at an obtuse angle from said unitary portion, said flared portion being unitary about said filter media, a mounting surface depends outwardly from said flared portion and is in a substantially common plane substantially parallel with a plane central with said filter media.

2. The nestable fluid filter of claim 1 wherein said frame has a polymeric material.

3. The nestable fluid filter of claim 2 wherein said polymeric material is selected from the group consisting of polyurethane, thermoplastic olefins, polycarbonates, polyesters, polypropylene, polyamides, polyethylene, polystyrene, and combinations thereof.

4. The nestable fluid filter of claim 2 wherein said polymeric material is polyurethane.

5. The nestable fluid filter of claim 2 wherein said polymeric material has a strengthening material.

6. The nestable fluid filter of claim 5 wherein said strengthening material is selected from the group consisting of paper, metal, plastic, glass fibers, and combinations thereof.

7. The nestable fluid filter of claim 1 wherein said frame is rectangular.

8. The nestable fluid filter of claim 5 wherein said strengthening material has rigid corner pieces.

9. The nestable fluid filter of claim 5 wherein said strengthening material has rigid side pieces.

10. The nestable fluid filter of claim 5 wherein said strengthening material has fine pieces throughout said polymeric material.

11. The nestable fluid filter of claim 2 wherein said polymeric material has a filler material.

12. The nestable fluid filter of claim 11 wherein said filler material is calcium carbonate.

13. The nestable fluid filter of claim 2 wherein said polymeric material has a colorant.

14. The nestable fluid filter of claim 2 wherein said polymeric material has a graphical display surface with an embossed design therein.

15. The nestable fluid filter of claim 1 wherein said filter media is pleated.

16. The nestable fluid filter of claim 1 wherein said filter media is a pad.

17. The nestable fluid filter of claim 15 wherein said filter media has a faceguard unitary with said pleats depending from said unitary portion.

18. The nestable fluid filter of claim 16 wherein said filter media has a faceguard unitary with said pad depending from said unitary portion.

19. The nestable fluid filter of claim 1 wherein said filter media and said frame are comprised of the same material, said frame having said material in a hardened state.

20. The nestable fluid filter of claim 1 wherein said mounting surface is a terminating edge of said unitary portion.

21. The nestable fluid filter of claim 1 wherein said mounting surface is a substantially flat surface substantially parallel with said filter media.

22. The nestable fluid filter of claim 21 wherein said mounting surface has a portion flaring outwardly at an obtuse angle from said mounting surface providing structural support to said frame.

23. A nestable fluid filter comprising a frame surrounding a filter media, said frame having an unitary portion unitary with an outer portion of said filter media, depending from said unitary portion is a portion flaring outwardly at an angle of more than 90° from said unitary portion, said flared portion being unitary about said filter media, said filter media and said frame have polyurethane, said polyurethane in said frame being in a rigid state.

24. A nestable fluid filter comprising a frame surrounding a filter media, said frame having an unitary portion unitary with an outer portion of said filter media, depending from said unitary portion is a portion flaring outwardly at an angle of more than 90° from said unitary portion, said flared portion being unitary about said filter media, said filter media has a faceguard unitary there with, said faceguard being in the form of strips depending from said frame.
